(19) United States
(12) Patent Application Publication
(10) Pub. No.: US 2005/0023260 A1
(43) Pub. Date: Feb. 3, 2005

(54) Semiconductor wafer dividing apparatus and semiconductor device manufacturing method

(76) Inventors: Shinya Takyu, Kitakatsushika-gun (JP); Tetsuya Kurosawa, Yokohama-shi (JP); Ninao Sato, Mitaka-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/846,673

(22) Filed: May 17, 2004

Related U.S. Application Data
(63) Continuation-in-part of application No. 10/390,900, filed on Mar. 19, 2003, now Pat. No. 6,756,562.

(30) Foreign Application Priority Data
Jan. 10, 2003 (JP) 2003-004767
Jan. 13, 2004 (JP) 2004-005549
Apr. 14, 2003 (DE) 10317115.0

(51) Int. Cl. B23K 26/14

(52) U.S. Cl. 219/121.67

(57) ABSTRACT

A semiconductor device manufacturing apparatus includes etching equipment, damage forming equipment, dividing equipment and removing equipment. The etching equipment etches a film formed on an element forming surface of a semiconductor wafer, thereby defining a dicing line or a chip-dividing line. The damage forming equipment forms damage layers used as starting points to divide a semiconductor wafer into discrete semiconductor chips on a rear surface side of the semiconductor wafer which is opposite to an element forming surface. The dividing equipment divides the semiconductor wafer into discrete semiconductor chips with the damage layers used as the starting points. The removing equipment removes a rear surface portion of the semiconductor wafer to at least a depth where the damage layers are no more present.

### CROSS-REFERENCE TO RELATED APPLICATIONS

This is a Continuation-in-Part application of U.S. patent application Ser. No. 10/390,900, filed Mar. 19, 2003, the entire contents of which are incorporated herein by reference.

This application is based upon and claims the benefit of priority from prior Japanese Patent Applications No. 2003-004767, filed Jan. 10, 2003; and No. 2004-005549, filed Jan. 13, 2004, the entire contents of both of which are incorporated herein by reference.

### BACKGROUND OF THE INVENTION

1. Field of the Invention

This invention relates to a semiconductor device manufacturing method and apparatus to discretely divide a semiconductor wafer into semiconductor chips (semiconductor elements) after elements are formed in the semiconductor wafer and more particularly to a technique for discretely dividing the semiconductor wafer.

2. Description of the Related Art

Conventionally, when a semiconductor wafer on which elements have been formed is discretely divided to form semiconductor chips, mechanical cutting (dividing by cutting using a diamond blade or grindstone), dividing by forming cut grooves and breaking, dividing by breaking with distortions and scratches used as starting points by use of a scriber (refer to Jpn. Pat. Appln. KOKOKU Publication No. H05-54262, for example), cutting by application of a laser beam, dividing by use of a combination of application of a laser beam and distortion (refer to Jpn. Pat. Appln. KOKAI Publication No. P2002-192367, for example) and the like are used.

FIGS. 1A and 1B show an extracted part of the conventional semiconductor device manufacturing process described above, FIG. 1A being a perspective view showing a step of forming cut grooves in a semiconductor wafer by use of a diamond blade and FIG. 1B being a cross sectional view showing a back-side grinding step. First, as shown in FIG. 1A, grooves 13-1, 13-2, 13-3, . . . for dividing are formed (half-cut) along dicing lines or chip dividing lines on an element forming surface 11A side of a semiconductor wafer 11 on which elements have been formed. After this, a protection film 14 is affixed to the element forming surface 11A of the semiconductor wafer 11 and then, as shown in FIG. 1B, a rear surface portion 11B of the semiconductor wafer 11 is ground to at least a depth Δ0 which reaches the grooves 13-1, 13-2, 13-3, . . . to divide the semiconductor wafer 11 into discrete semiconductor chips 11-1, 11-2, 11-3, . . . .

Alternatively, a dicing tape is affixed to the rear surface 11B of the semiconductor wafer 11, which is opposite to the element forming surface 11A, and the semiconductor wafer is cut (full cut) along the dicing lines or chip dividing lines by use of the diamond blade 12 in some cases.

However, in the mechanical cutting process such as the blade dicing process, cutting streaks (scratches or distortions) may occur on the side surface of the semiconductor chip as shown in FIG. 2A. Further, chippings may occur on the element forming surface (also on the rear surface in the case of full cut) as shown in FIG. 2B.

This applies to a case wherein scratches or distortions are formed by use of a scriber and the semiconductor wafer is divided by breaking and, as shown in FIG. 3A, scratches (less than 5 μm) or distortions (approximately several μm) may occur on the side surface of the semiconductor chip. Further, as shown in FIG. 3B, chippings may occur on the element forming surface.

In the cutting process by application of a laser beam, occurrence of cutting streaks and chippings by mechanical cutting can be prevented, but distortions (damages) occur on the side surface of the semiconductor chip as shown in FIG. 4A. Further, as shown in FIG. 4B, the side surface of the semiconductor chip becomes uneven and the mechanical strength is lowered. In addition, melted Si is re-crystallized so that adjacent elements will tend to interfere with each other, thereby causing chippings to occur. Further, there occurs a problem that the element characteristic is deteriorated (for example, the pause characteristic of a DRAM is degraded) or a melted portion is attached to the wiring surface by heat generated at the time of laser application.

Thus, in the conventional semiconductor device manufacturing method and apparatus, when the semiconductor wafer is cut and divided into discrete semiconductor chips, cutting streaks (scratches or distortions) may occur on the side surface of the semiconductor chip, damages by heat may occur, the characteristic of the semiconductor chip may be deteriorated, faults may occur and the resistance to bending or breaking may be lowered. Further, even if the semiconductor chip does not become faulty, cutting streaks and uneven portions caused by application of the laser beam will remain on the peripheral portion of the semiconductor chip and the shape and quality thereof are poor.

### BRIEF SUMMARY OF THE INVENTION

A semiconductor device manufacturing apparatus according to an aspect of the invention comprises etching equipment which etches a film formed on an element forming surface of a semiconductor wafer, thereby defining a dicing line or a chip-dividing line, damage forming equipment which forms damage layers used as starting points to divide a semiconductor wafer into discrete semiconductor chips, on a rear surface side of the semiconductor wafer which is opposite to the element forming surface, dividing equipment which divides the semiconductor wafer into discrete semiconductor chips with the damage layers used as the starting points, and a removing equipment which removes a rear surface portion of the semiconductor wafer to at least a depth where the damage layers are no more present.

According to another aspect of the present invention, there is provided a semiconductor device manufacturing apparatus comprising damage forming equipment which forms damage layers used as starting points to divide a semiconductor wafer into discrete semiconductor chips, on a rear surface side of the semiconductor wafer which is opposite to an element forming surface, hole-making equipment which makes holes in the semiconductor wafer along a dicing line or a chip-diving line so that the semiconductor wafer may be broken along the dicing line or the chip-dividing line, dividing equipment which divides the semiconductor wafer into discrete semiconductor chips with the damage layers used as the starting points, and a removing equipment which removes a rear surface portion of the semiconductor wafer to at least a depth where the damage layers are no more present.

According to still another aspect of the invention, there is provided a semiconductor device manufacturing method which comprises etching a film formed on an element forming surface of a semiconductor wafer, thereby defining a dicing line or a chip-dividing line, forming a damage layer used as starting points to divide a semiconductor wafer into discrete semiconductor chips, on a rear surface side of the semiconductor wafer which is opposite to the element forming surface, dividing the semiconductor wafer into discrete semiconductor chips with the damage layer used as the starting points, and removing a rear surface portion of the semiconductor wafer to at least a depth where the damage layer is no more present.

According to still another aspect of the invention, there is provided a semiconductor device manufacturing method which comprises forming damage layers used as starting points to divide a semiconductor wafer into discrete semiconductor chips, on a rear surface side of the semiconductor wafer which is opposite to an element forming surface, making holes in the semiconductor wafer along a dicing line or a chip-diving line so that the semiconductor wafer may be broken along the dicing line or the chip-dividing line, dividing the semiconductor wafer into discrete semiconductor chips with the damage layers used as the starting points, and removing a rear surface portion of the semiconductor wafer to at least a depth where the damage layers are no more present.

### BRIEF DESCRIPTION OF THE SEVERAL VIEWS OF THE DRAWING

FIG. 1A is a perspective view showing a step of forming cut grooves in a semiconductor wafer by use of a diamond blade and showing an extracted part of a conventional semiconductor device manufacturing process;

FIG. 1B is a cross sectional view showing a back-side grinding step and showing an extracted part of a conventional semiconductor device manufacturing process;

FIG. 2A is a microphotograph of the side surface of a semiconductor chip when a semiconductor wafer is divided by blade dicing;

FIG. 2B is a microphotograph of the element forming surface side when a semiconductor wafer is divided by blade dicing;

FIG. 3A is a microphotograph of the side surface of a semiconductor chip when a semiconductor wafer is divided by use of a scriber;

FIG. 3B is a microphotograph of the element forming surface side when a semiconductor wafer is divided by use of a scriber;

FIG. 4A is a microphotograph of the side surface of a semiconductor chip when a semiconductor wafer is divided by application of a laser beam;

FIG. 4B is a microphotograph of the element forming surface side when a semiconductor wafer is divided by application of a laser beam;

FIG. 5 is a perspective view showing a dicing tape affixing step, for illustrating a semiconductor device manufacturing method and apparatus according to a first embodiment of the present invention;

FIG. 6 is a perspective view showing a step of forming cut grooves used as division starting points, for illustrating the semiconductor device manufacturing method and apparatus according to the first embodiment of the present invention;

FIG. 7 is a perspective view showing a wafer dividing step, for illustrating the semiconductor device manufacturing method and apparatus according to the first embodiment of the present invention;

FIG. 8 is a cross sectional view showing a back-side grinding step, for illustrating the semiconductor device manufacturing method and apparatus according to the first embodiment of the present invention;

FIG. 9 is a perspective view showing a pickup tape affixing step, for illustrating the semiconductor device manufacturing method and apparatus according to the first embodiment of the present invention;

FIG. 10A is a microphotograph of the element forming surface side of a mirror-finished portion of a semiconductor chip formed by the semiconductor device manufacturing method and apparatus according to the first embodiment of the present invention;

FIG. 10B is a microphotograph of the side surface of a semiconductor chip formed by the semiconductor device manufacturing method and apparatus according to the first embodiment of the present invention;

FIG. 11 is a perspective view showing a dicing tape affixing step, for illustrating a semiconductor device manufacturing method and apparatus according to a second embodiment of the present invention;

FIG. 12 is a perspective view showing a step of forming scratches or distortions used as division starting points, for illustrating the semiconductor device manufacturing method and apparatus according to the second embodiment of the present invention;

FIG. 13 is a perspective view showing a wafer dividing step, for illustrating the semiconductor device manufacturing method and apparatus according to the second embodiment of the present invention;

FIG. 14 is a cross sectional view showing a back-side grinding step, for illustrating the semiconductor device manufacturing method and apparatus according to the second embodiment of the present invention;

FIG. 15 is a perspective view showing a pickup tape affixing step, for illustrating the semiconductor device manufacturing method and apparatus according to the second embodiment of the present invention;

FIG. 16 is a perspective view showing a dicing tape affixing step, for illustrating a semiconductor device manufacturing method and apparatus according to a third embodiment of the present invention;

FIG. 17 is a perspective view showing a step of forming re-crystallization layers used as division starting points, for illustrating the semiconductor device manufacturing method and apparatus according to the third embodiment of the present invention;

FIG. 18 is a perspective view showing a wafer dividing step, for illustrating the semiconductor device manufacturing method and apparatus according to the third embodiment of the present invention;

FIG. 19 is a cross sectional view showing a back-side grinding step, for illustrating the semiconductor device manufacturing method and apparatus according to the third embodiment of the present invention;

FIG. 20 is a perspective view showing a pickup tape affixing step, for illustrating the semiconductor device manufacturing method and apparatus according to the third embodiment of the present invention;

FIG. 21 is a perspective view showing a step of forming re-crystallization layers used as division starting points, for illustrating a semiconductor device manufacturing method and apparatus according to a fourth embodiment of the present invention;

FIG. 22 is a cross sectional view showing a back-side grinding step, for illustrating the semiconductor device manufacturing method and apparatus according to the fourth embodiment of the present invention;

FIG. 23 is a schematic view showing an ice chuck, for illustrating a semiconductor device manufacturing method and apparatus according to a fifth embodiment of the present invention;

FIG. 24 is a schematic view showing another example of the ice chuck, for illustrating the semiconductor device manufacturing method and apparatus according to the fifth embodiment of the present invention;

FIG. 25 is a perspective view showing part of a manufacturing process and a manufacturing apparatus, for illustrating a semiconductor device manufacturing method and apparatus according to a sixth embodiment of the present invention;

FIG. 26 is a perspective view of a semiconductor wafer, explaining a semiconductor device manufacturing apparatus and a semiconductor device manufacturing method, both according to a seventh embodiment of the invention, and illustrating the step of etching a film formed on an element forming surface, to define a dicing line or a chip-dividing line;

FIG. 27 is a perspective view of a semiconductor wafer, explaining the seventh embodiment of the invention and showing the step of affixing a dicing tape to the semiconductor wafer;

FIG. 28 is a perspective view of a semiconductor wafer, explaining the seventh embodiment of the invention and depicting the step of forming a damage layers used as points at which the chip-dividing starts;

FIG. 29 is a perspective view of a semiconductor wafer, explaining the seventh embodiment of the invention and showing the step of dividing the wafer;

FIG. 30 is a cross sectional view of a semiconductor wafer, explaining the seventh embodiment of the invention and illustrating the step of polishing that surface of the wafer that is opposite to the element forming surface thereof;

FIG. 31 is a perspective view of a semiconductor wafer, explaining the seventh embodiment of the invention and illustrating the step of removing the tape and affixing a new tape;

FIG. 32A is a plan view of a semiconductor wafer, explaining a semiconductor device manufacturing apparatus and a semiconductor device manufacturing method, both according to an eighth embodiment of the invention;

FIG. 32B is a sectional view taken along line 32B-32B in FIG. 32A, explaining the eighth embodiment; and

FIG. 33 is a perspective view showing part of a manufacturing process, for illustrating a semiconductor device manufacturing method and apparatus according to a ninth embodiment of the present invention.

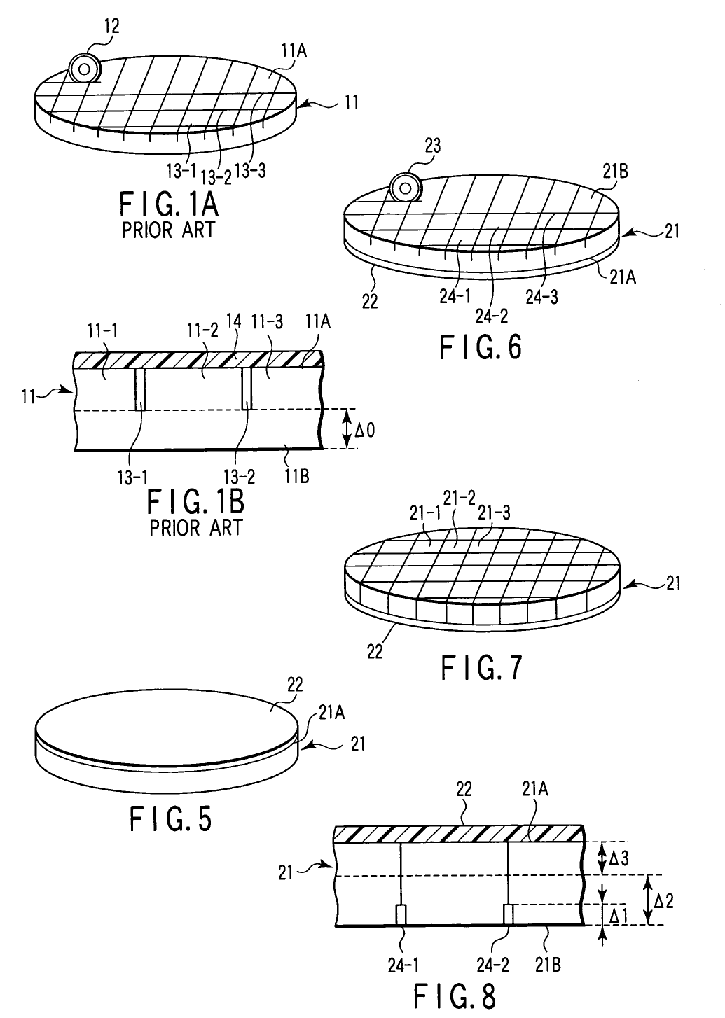

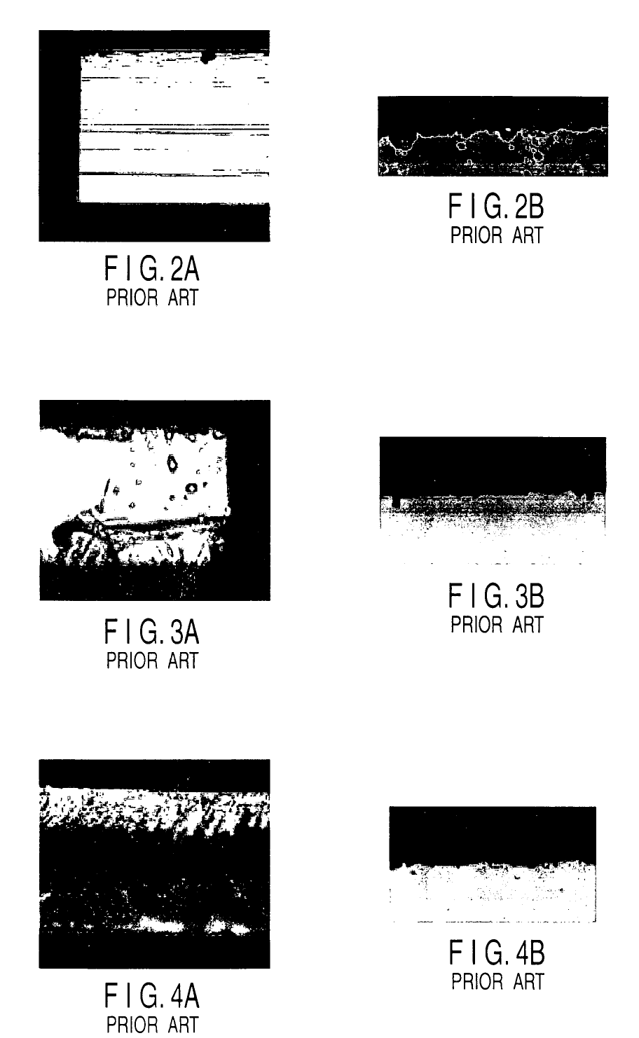

### DETAILED DESCRIPTION OF THE INVENTION

[First Embodiment]

FIGS. 5 to 9 show parts of a manufacturing process and parts of a manufacturing apparatus, for illustrating a semiconductor device manufacturing method and apparatus according to a first embodiment of the present invention.

First, as shown in FIG. 5, a dicing tape (protection member, protection tape or holding tape) 22 is affixed to an element forming surface 21A side of a semiconductor wafer 21 on which elements have been formed.

Next, as shown in FIG. 6, grooves (damage regions or damage layers) 24-1, 24-2, 24-3, . . . used as starting points to divide the semiconductor wafer into discrete semiconductor chips are formed on a rear surface 21B side of the semiconductor wafer 21 which is opposite to the element forming surface 21A by use of a diamond blade 23. The grooves 24-1, 24-2, 24-3, . . . are formed shallower than the thickness of the semiconductor chip obtained at the time of completion. Further, it is preferable to form the grooves 24-1, 24-2, 24-3, . . . in a direction corresponding to the crystallization direction of the semiconductor wafer (for example, Si) since the grooves are used as the starting points of cleavage.

Next, as shown in FIG. 7, a breaking process is performed to cleave the semiconductor wafer 21 by using the grooves 24-1, 24-2, 24-3, . . . as the starting points to form discrete semiconductor chips 21-1, 21-2, 21-3, . . . .

After this, as shown in FIG. 8, a portion on the rear surface 21B side of the discretely divided semiconductor wafer 21 is ground and removed until the semiconductor wafer comes to have preset thickness. If the depth of the grooves 24-1, 24-2, 24-3, . . . is Δ1 and the grinding amount is Δ2, then damage layers such as scratches or distortions formed on the side surfaces of the semiconductor chips 21-1, 21-2, 21-3, . . . by forming the grooves 24-1, 24-2, 24-3, . . . can be removed by setting up the relation of Δ1<Δ2. For example, since the wafer thickness is 725 μm in the case of an 8-inch semiconductor wafer, Δ2 becomes equal to 695 to 275 μm if the final thickness Δ3 of the semiconductor chips 21-1, 21-2, 21-3, . . . is 30 to 450 μm and therefore the depth Δ1 of the grooves 24-1, 24-2, 24-3, . . . can be freely and selectively set in a range shallower than 695 to 275 μm.

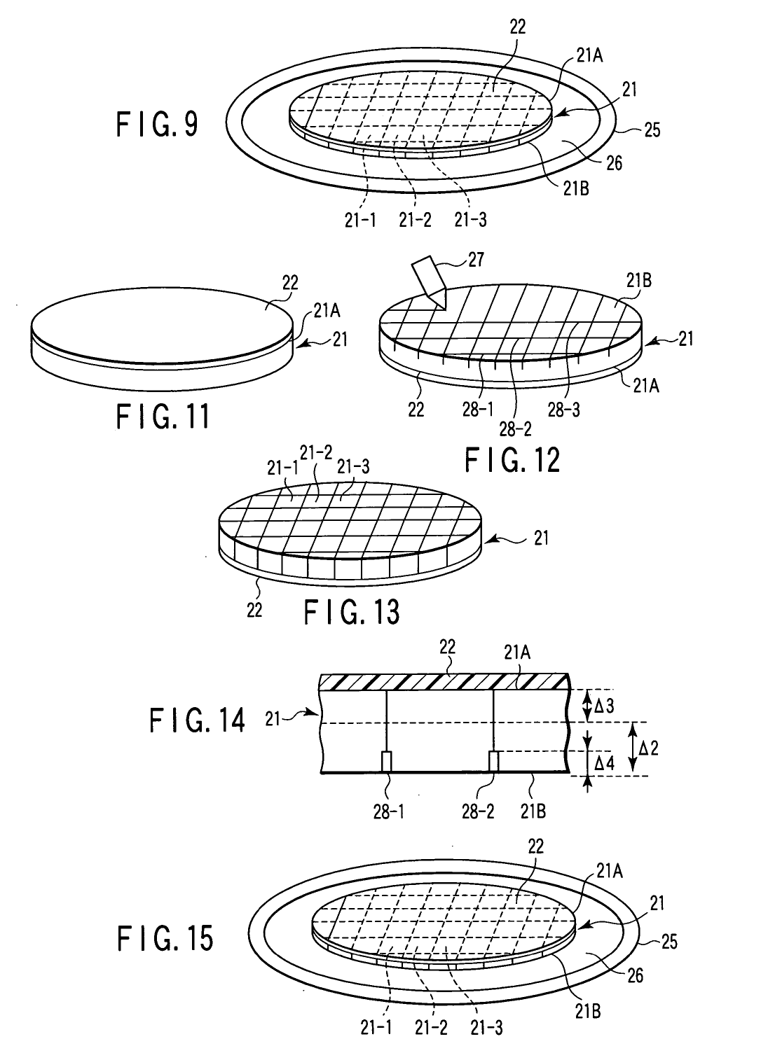

Next, as shown in FIG. 9, after a pickup tape 26 mounted on a wafer ring 25 is affixed to the rear surface of the semiconductor wafer 21, the protection tape 22 on the element forming surface 21A side is peeled.

Then, the semiconductor chips 21-1, 21-2, 21-3, . . . picked up by use of a picker are mounted on lead frames or TAB tapes and sealed into resin or ceramic packages, respectively, to complete semiconductor devices.

According to the manufacturing method and the apparatus with the above configuration, since the grooves 24-1, 24-2, 24-3, . . . are formed in a region (discarding portion) which is to be removed in the back-side grinding process, the damage layers are not left behind on the semiconductor chips 21-1, 21-2, 21-3, . . . obtained after the back-side grinding process and occurrence of distortion of Si and minute cracks of the separation surface and edge portion can be prevented. Further, since the side surface of the semiconductor chip sealed into the package is a cleavage plane, uneven portions and scratches are not formed on the element forming surface and side surface of the semiconductor chip and the quality and shape thereof are good as shown in FIGS. 10A and 10B.

Therefore, a deterioration in the characteristic of the semiconductor chip, occurrence of faults and a lowering in the resistance to bending or breaking can be suppressed.

[Second Embodiment]

FIGS. 11 to 15 sequentially shows parts of a manufacturing process and parts of a manufacturing apparatus, for illustrating a semiconductor device manufacturing method and apparatus according to a second embodiment of the present invention.

First, as shown in FIG. 11, a dicing tape (protection member, protection tape or holding tape) 22 is affixed to an element forming surface 21A side of a semiconductor wafer 21 on which elements have been formed.

Next, as shown in FIG. 12, scratches or distortions (damage regions or damage layers) 28-1, 28-2, 28-3, . . . used as starting points to divide the semiconductor wafer into discrete semiconductor chips are formed on a rear surface 21B side of the semiconductor wafer 21 which is opposite to the element forming surface 21A by use of a diamond scriber 27. The scratches or distortions 28-1, 28-2, 28-3, . . . are formed shallower than the thickness of the semiconductor chip obtained at the time of completion. Further, it is preferable to form the scratches or distortions 28-1, 28-2, 28-3, . . . in a direction corresponding to the crystallization direction of the semiconductor wafer (for example, Si) since the scratches or distortions are used as the starting points of cleavage.

Next, as shown in FIG. 13, a breaking process is performed to cleave the semiconductor wafer 21 by using the scratches or distortions 28-1, 28-2, 28-3, . . . as the starting points to form discrete semiconductor chips 21-1, 21-2, 21-3, . . . .

After this, as shown in FIG. 14, a portion on the rear surface 21B side of the discretely divided semiconductor wafer 21 is ground and removed until the semiconductor wafer comes to have preset thickness. If the depth of the scratches or distortions 28-1, 28-2, 28-3, . . . is Δ4 and the grinding amount is Δ2, then damage layers such as scratches or distortions formed on the side surfaces of the semiconductor chips 21-1, 21-2, 21-3, . . . can be removed by setting up the relation of Δ4 <Δ2. Since the wafer thickness is 725 μm in the case of an 8-inch semiconductor wafer, for example, Δ2 becomes equal to 695 to 275 μm if the final thickness Δ3 of the semiconductor chips 21-1, 21-2, 21-3, . . . is 30 to 450 μm and therefore the depth Δ4 of the scratches or distortions 28-1, 28-2, 28-3, . . . can be freely and selectively set in a range shallower than 695 to 275 μm.

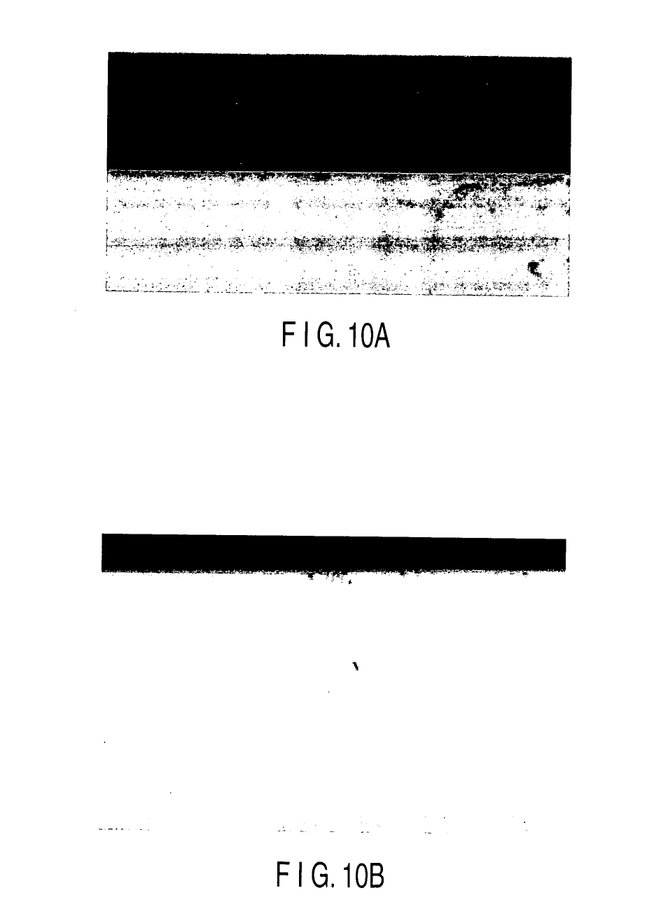

Next, as shown in FIG. 15, after a pickup tape 26 mounted on a wafer ring 25 is affixed to the rear surface of the semiconductor wafer 21, the protection tape 22 on the element forming surface 21A side is peeled.

Then, the semiconductor chips 21-1, 21-2, 21-3, . . . picked up by use of a picker are mounted on lead frames or TAB tapes and sealed into resin or ceramic packages, respectively, to complete semiconductor devices.

According to the apparatus with the above configuration and the manufacturing method, since the scratches or distortions 28-1, 28-2, 28-3, . . . are formed in a region (discarding portion) which is to be removed in the back-side grinding process, damage layers are not left behind after the back-side grinding process and occurrence of distortion of Si and minute cracks of the separation surface and edge portion can be prevented. Further, since the side surface of the semiconductor chip sealed into the package is a cleavage plane, uneven portions and scratches are not formed on the element forming surface and side surface of the semiconductor chip and the quality and shape thereof are good.

Therefore, a deterioration in the characteristic of the semiconductor chip, occurrence of faults and a lowering in the resistance to bending or breaking can be suppressed.

[Third Embodiment]

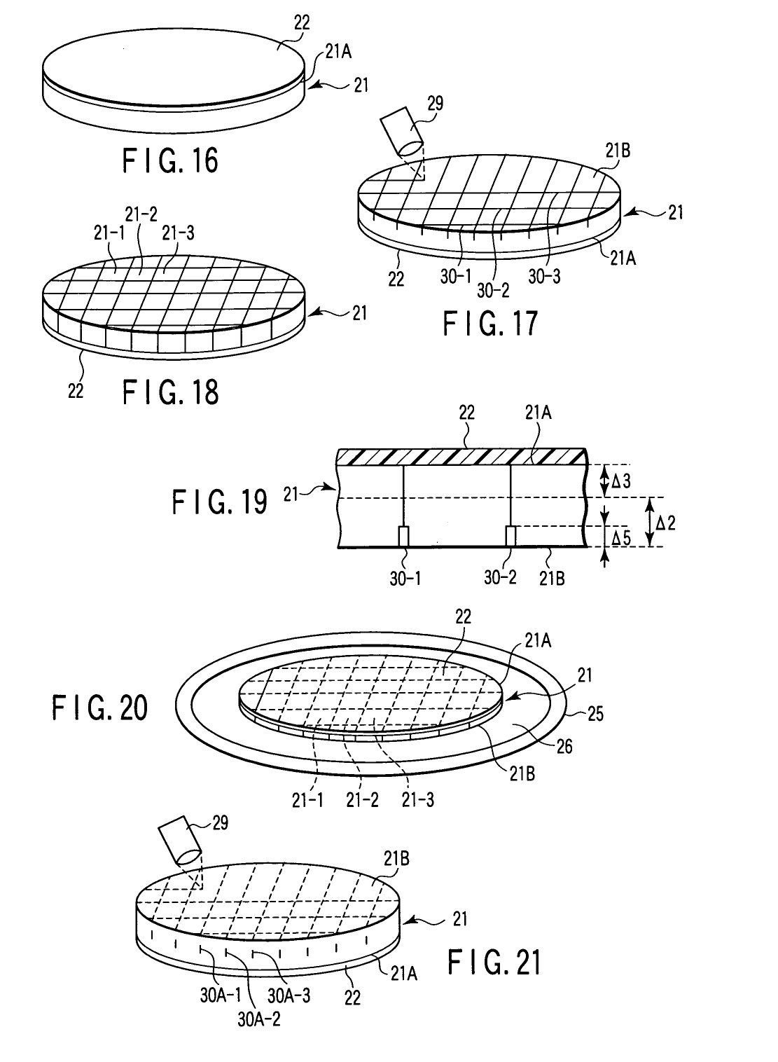

FIGS. 16 to 20 show parts of a manufacturing process and parts of a manufacturing apparatus, for illustrating a semiconductor device manufacturing method and apparatus according to a third embodiment of the present invention.

First, as shown in FIG. 16, a dicing tape (protection member, protection tape or holding tape) 22 is affixed to an element forming surface 21A side of a semiconductor wafer 21 on which elements have been formed.

Next, as shown in FIG. 17, Si re-crystallization layers (damage layers or damage regions) 30-1, 30-2, 30-3, . . . used as starting points to divide the semiconductor wafer into discrete semiconductor chips are formed on a rear surface 21B side of the semi-conductor wafer 21 which is opposite to the element forming surface 21A by irradiating a laser beam from a laser irradiation device 29. The re-crystallization layers 30-1, 30-2, 30-3, . . . are formed shallower than the thickness of the semiconductor chip obtained at the time of completion. Further, it is preferable to form the re-crystallization layers 30-1, 30-2, 30-3, . . . in a direction corresponding to the crystallization direction of the semiconductor wafer (for example, Si) since the re-crystallization layers are used as the starting points of cleavage.

Next, as shown in FIG. 18, a breaking process is performed to cleave the semiconductor wafer 21 by using the re-crystallization layers 30-1, 30-2, 30-3, . . . as the starting points to form discrete semiconductor chips 21-1, 21-2, 21-3, . . . .

After this, as shown in FIG. 19, a portion on the rear surface 21B side of the discretely divided semiconductor wafer 21 is ground and removed until the semiconductor wafer comes to have preset thickness. If the depth of the re-crystallization layers 30-1, 30-2, 30-3, . . . is Δ5 and the grinding amount is Δ2, then damage layers formed on the side surfaces of the semiconductor chips 21-1, 21-2, 21-3, . . . by forming the re-crystallization layers 30-1, 30-2, 30-3, . . . can be removed by setting up the relation of Δ5 <Δ2. Since the wafer thickness is 725 μm in the case of an 8-inch semiconductor wafer, for example, Δ2 becomes equal to 695 to 275 μm if the final thickness Δ3 of the semiconductor chips 21-1, 21-2, 21-3, . . . is 30 to 450 μm and therefore the depth Δ5 of the re-crystallization layers 30-1, 30-2, 30-3, . . . can be freely and selectively set in a range shallower than 695 to 275 μm.

Next, as shown in FIG. 20, after a pickup tape 26 mounted on a wafer ring 25 is affixed to the rear surface of the semiconductor wafer 21, the protection tape 22 on the element forming surface 21A side is peeled.

Then, the semiconductor chips 21-1, 21-2, 21-3, . . . picked up by use of a picker are mounted on lead frames or TAB tapes and sealed into resin or ceramic packages, respectively, to complete semiconductor devices.

According to the apparatus with the above configuration and the manufacturing method, since the Si re-crystallization layers 30-1, 30-2, 30-3, . . . are formed in a region (discarding portion) which is to be removed in the back-side grinding process, damage layers are not left behind after the back-side grinding process and occurrence of distortion of Si and minute cracks of the separation surface and edge portion can be prevented. Further, since the side surface of the semiconductor chip sealed into the package is a cleavage plane, uneven portions and scratches are not formed on the element forming surface and side surface of the semiconductor chip and the quality and shape thereof are good.

Therefore, a deterioration in the characteristic of the semiconductor chip, occurrence of faults and a lowering in the resistance to bending or breaking can be suppressed.

[Fourth Embodiment]

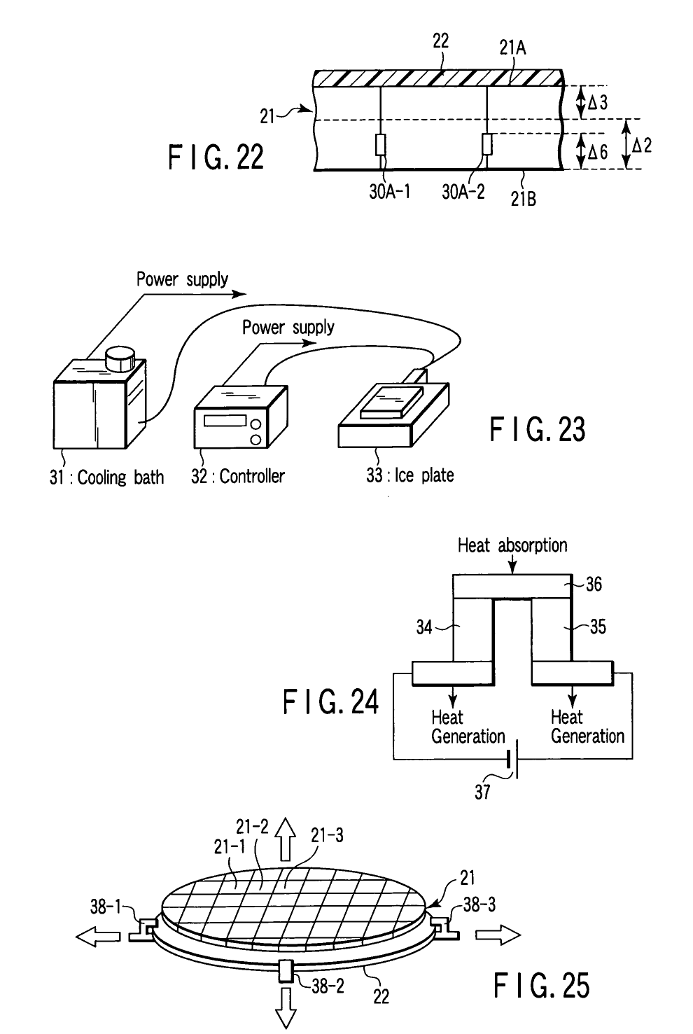

FIGS. 21 and 22 sequentially show parts of a manufacturing process and parts of a manufacturing apparatus, for illustrating a semiconductor device manufacturing method and apparatus according to a fourth embodiment of the present invention.

In the fourth embodiment, silicon re-crystallization regions 30A-1, 30A-2, 30A-3, . . . are formed in a semiconductor wafer 21 by focusing a laser beam on the internal portion of the semiconductor wafer 21 and adjusting laser beam power when the laser beam is applied.

Thus, in a case where the silicon re-crystallization regions are formed in the semiconductor wafer, damage layers can be removed by setting up the relation of Δ6 <Δ2 when the depth of the re-crystallization regions 30A-1, 30A-2, 30A-3, . . . is Δ6 and the grinding amount is Δ2.

Therefore, the same operation and effect as those of the firs to third embodiments can be attained.

[Fifth Embodiment]

FIGS. 23 and 24 sequentially show parts of a manufacturing apparatus, for illustrating a semiconductor device manufacturing method and apparatus according to a fifth embodiment of the present invention.

In the third and fourth embodiments, the silicon re-crystallization layers 30-1, 30-2, 30-3, . . . or 30A-1, 30A-2, 30A-3, . . . are formed in the semiconductor wafer 21 by irradiating the laser beam. However, there occurs a possibility that laser processing gives a bad influence on the semiconductor chip by generation of heat.

Therefore, in the fifth embodiment, the semiconductor wafer 21 is held by use of an ice chuck shown in FIG. 23 and a laser beam is applied to the semiconductor wafer 21 while it is set in a cooled state.

The ice chuck shown in FIG. 23 includes a cooling bath 31, controller 32 and ice plate 33. A refrigerant is supplied from the cooling bath 32 to the ice plate 33 to cool the same. The semiconductor wafer 21 is held on the ice plate 33 and cooled. The temperature of the ice plate 33 is controlled in a temperature range of approximately −40° C. to 5° C. by the controller 32.

According to the manufacturing method and the apparatus with the above configuration, an influence of heat given to the semiconductor chip at the time of laser processing can be significantly reduced and occurrence of an operation failure of the semiconductor chip, for example, a degraded pause characteristic of a DRAM can be suppressed.

The ice chuck is not limited to the configuration containing the cooling bath 31 as shown in FIG. 23 and can be provided with a thermoelectric cooling unit using a Peltier element as shown in FIG. 24. The Peltier element includes a P-type element 34, N-type element 35 and metal electrode 36. Voltage is applied to the Peltier element from a power supply 37 to generate or absorb heat by causing a current to flow across the contact surface between the different types of metals.

The ice chuck using the Peltier element makes it easy to control temperatures and cool an object to a set temperature in a short period of time.

[Sixth Embodiment]

FIG. 25 is a perspective view showing part of a manufacturing process and a manufacturing apparatus, for illustrating a semiconductor device manufacturing method and apparatus according to a sixth embodiment of the present invention.

In the first to third embodiments, the semiconductor wafer is divided by cleavage and breaking. In the sixth embodiment, a dicing tape 22 is stretched in directions indicated by arrows in the drawing by use of stretching jigs 38-1, 38-2, 38-3, . . . to divide the semiconductor wafer by using grooves 24-1, 24-2, 24-3, . . . , scratches or distortions 28-1, 28-2, 28-3, . . . , re-crystallization layers 30-1, 30-2, 30-3, . . . , or re-crystallization layers 30A-1, 30A-2, 30A-3, . . . as starting points.

Thus, the semiconductor wafer 21 can be divided into discrete semiconductor chips 21-1, 21-2, 21-3, . . . by stretching the dicing tape 22.

[Seventh Embodiment]

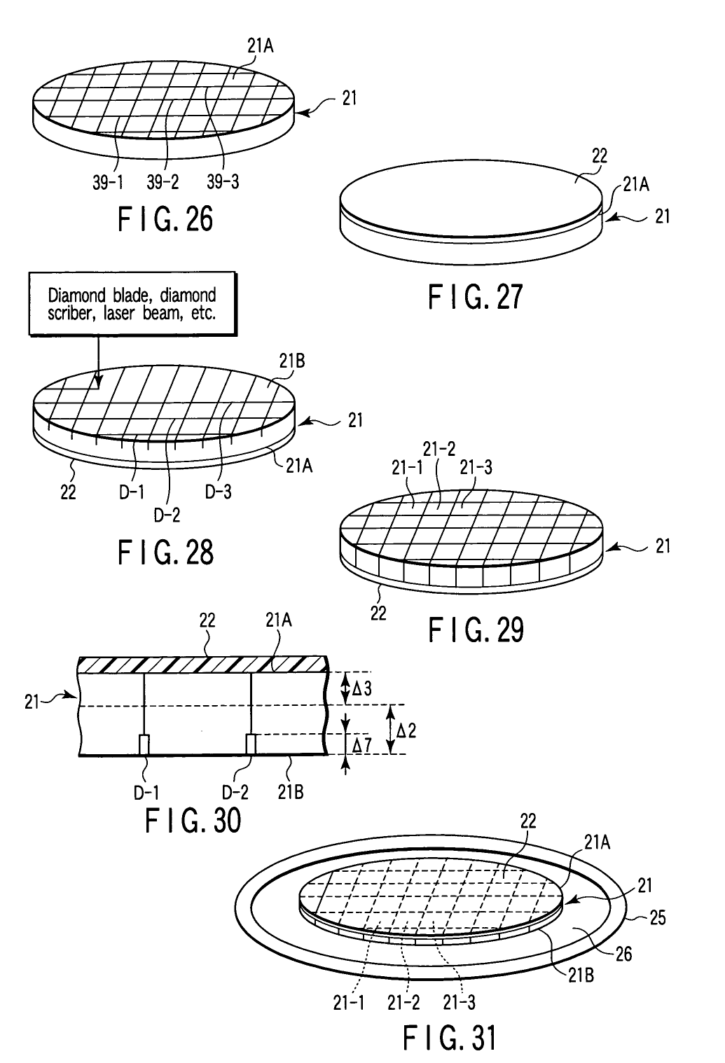

FIGS. 26 to 31 illustrate a semiconductor device manufacturing apparatus and a semiconductor device manufacturing method, both according to a seventh embodiment of the invention. More precisely, these figures show a part of the apparatus and a part of the method.

First, the films covering the dicing lines and chip-dividing lines on the element forming surface 21A of a semiconductor wafer 21 are removed by etching such as RIE (Reactive Ion Etching) as is illustrated in FIG. 26. The films thus removed are the inter-layer insulating film formed in the process of forming the elements and the polysilicon layer and metal layer used in TEG. The regions 39-1, 39-2, 39-3, . . . removed by etching are so thick that the major surface of the wafer 21 is exposed.

The thickness of these regions 39-1, 39-2, 39-3, . . . need not be controlled to a precise value, nonetheless. The major surface of the semiconductor wafer 21 may remain covered in some parts with, for example, the inter-layer insulating film. Alternatively, the major surface of the wafer 21 may be etched to some extent.

Thereafter, as shown in FIG. 27, a dicing tape 22 (i.e., a protective member, a protective tape or a holding tape) is affixed to the element forming surface 21A of the semiconductor wafer 21.

Then, as FIG. 28 shows, damage layers (or damage regions) D-1, D-2, D-3, . . . are formed in that surface 21B of the wafer 21, which faces away from the element forming surface 21A. The damage layers D-1, D-2, D-3, . . . serve as points at which the dividing of the wafer 21 is started. The damage layers D-1, D-2, D-3, . . . are thinner than the elements to be formed and are positioned to align with the above-mentioned dicing lines or chip dividing lines. Since the damage layers D-1, D-2, D-3, . . . define the points at which the cleavage of the wafer 21, it is desired that they extend in the crystal (e.g., Si crystal) orientation of the semiconductor wafer 21.

Next, the wafer 21 is broken as shown in FIG. 29. In other words, cleavage starts at the damage layers D-1, D-2, D-3, . . . . Semiconductor elements 21-, 21-2, 21-3, . . . are thereby obtained.

As FIG. 30 shows, the rear surface 21B of the wafer 21 is polished, thus removing a surface region of a prescribed thickness Δ2. Thickness Δ2 is greater than the depth Δ7 of the damage layers D-1, D-2, D-3, . . . . Thus, the scars, strain and re-crystallized layers made in and formed on the sides of the elements 21-1, 21-2, 21-3, . . . at the timing of forming the damage layers can be removed. Assume that the wafer 21 is an 8-inch semiconductor wafer that is 725 μm thick. If the semiconductor elements 21-1, 21-2, 21-3, . . . have thickness Δ3 of 30 to 450 μm, the thickness Δ2 will be 695 to 265 μm. Hence, the depth Δ7 of the damage layers D-1, D-2, D-3, . . . can be less than any value within the range of 695 to 275 μm.

Subsequently, a pickup tape 26 attached to the wafer ring 26 is affixed to the rear surface 21B of the semiconductor wafer 21 as is illustrated in FIG. 31. Then, the dicing tape 22 is peeled from the element forming surface 21A.

The semiconductor elements 21-1, 21-2, 21-3, . . . are picked up by using a picker and mounted on lead frames or TAB tapes. The elements 21-1, 21-2, 21-3, . . . are then sealed in resin packages or ceramic packages. Thus, semiconductor devices are manufactured.

In the apparatus and method described above, the damage layers D-1, D-2, d-3, . . . are formed in that surface region of the semiconductor wafer 21, which will be removed by polishing the rear surface of the wafer 21. Hence, no damage layers will remain on the semiconductor elements 21-1, 21-2, 21-3, . . . obtained by breaking the wafer 21, the Si crystals will have no strain, and the surfaces and edges of each element will have no cracks. The element forming surface and sides of each element will have no scars, dents or projections, because the sides of the element are cleavage surfaces.

In each embodiment described above, not only the semiconductor (silicon) wafer 21, but also the various films on the major surface of the wafer 21 are completely cut. This is because those regions of the films which cover the dicing lines or chip dividing lines have been removed.

This prevents the semiconductor elements from being degraded in characteristics and from having defects or a decrease in anti-breaking strength.

As indicated above, the films covering the dicing lines or chip dividing lines are removed by etching from the semiconductor wafer before a dicing tape is affixed to the semiconductor wafer 21 on which semiconductor elements have already been formed. Instead, the films may be removed after the damage layers are formed and before the wafer is broken by cleavage.

[Eighth Embodiment]

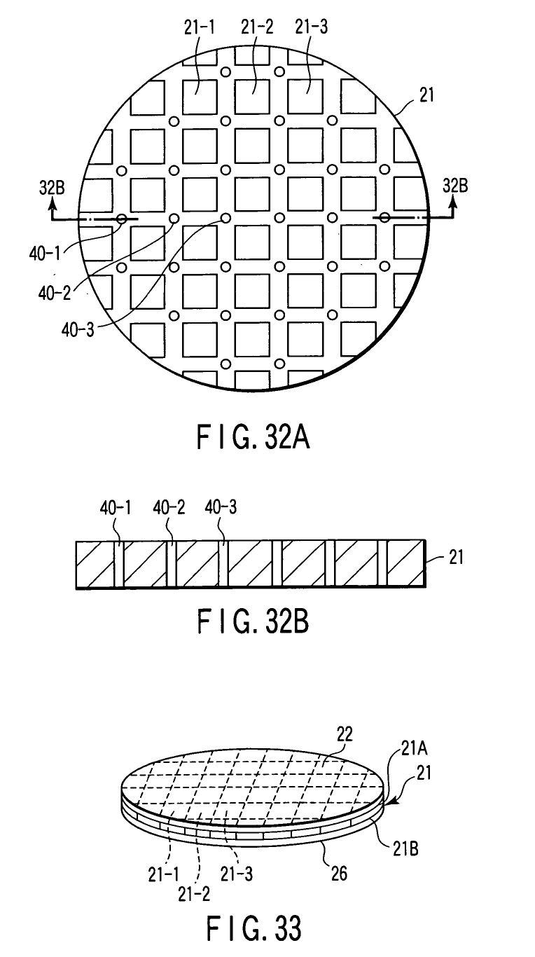

FIG. 32A and FIG. 32B illustrate a semiconductor device manufacturing apparatus and a semiconductor device manufacturing method, both according to an eighth embodiment of this invention. More correctly, FIG. 32A is a plan view of a semiconductor wafer, and FIG. 32B is a sectional view of the wafer, taken along line 32B-32B in FIG. 32A.

In the eight embodiment, the semiconductor wafer 21 has through holes 40-1, 40-2, 40-3, . . . made at the intersections of the dicing lines or chip dividing lines. Thus, four holes are made at the four corners of each of the semiconductor elements 31-1, 21-2, 21-3, . . . by performing etching such as RIE on the wafer 21 or by applying a laser beam to the wafer 21. The through holes 40-1, 40-2, 40-3, . . . prevent cracks from developing in the element forming region when the wafer 21 is divided into chips.

The through holes 40-1, 40-2, 40-3, . . . may be made before the elements are formed, after the elements are formed, before the damage layers are formed, or after the damage layers are formed.

The other steps of manufacturing in the eighth embodiment are identical to those of any one of the first to seventh embodiments.

The eighth embodiment achieves the same advantages as the first to seventh embodiments. The achieves an additional advantage in that the through holes 40-1, 40-2, 40-3, . . . help to braking the wafer 21 along the dicing lines or the chip dividing lines. In other words, the wafer 21 is not broken in undesirable manners.

This prevents the semiconductor elements from being degraded in characteristics and from having defects or a decrease in anti-breaking strength.

Through holes may be made not only at the intersections of the dicing lines or chip dividing lines, but also at other points in the dicing or chip dividing lines. Further, more or less through holes than in the case shown in FIG. 32A may be made in the wafer 21, in accordance with the diameter and thickness of the semiconductor wafer 21. Further more, it can be use the holes not through the wafer 21.

[Ninth Embodiment]

FIG. 33 is a perspective view showing part of a manufacturing process, for illustrating a semiconductor device manufacturing method and apparatus according to a ninth embodiment of the present invention.

In each of the above embodiments, a case where the wafer ring 25 is used when the pickup tape 26 is affixed is explained as an example. However, as shown in FIG. 33, a pickup tape 26 can be affixed and used instead of the dicing tape 22 without using a wafer ring 25.

This invention is not limited to the first to ninth embodiments and can be variously modified without departing from the technical scope thereof.

Various modifications are explained in detail below.

[Modification 1]

In the first to third embodiments, only the dicing tape 22 is affixed to the element forming surface 21A of the semiconductor wafer 21, but it is possible to affix a dicing tape 22 mounted on a wafer ring.

The wafer ring can be used depending on the configuration of the manufacturing apparatus or the like.

[Modification 2]

In the first to third embodiments, since scratches or chippings which may occur at the time of back-side grinding of the semiconductor chip can be removed with higher precision if the grinding surface is etched (for example, by dry etching, wet etching, gas etching, CMP) after back-side grinding, the resistance to bending or breaking at the time of picking-up of the semiconductor chip can be enhanced.

[Modification 3]

In the first to third embodiments, the rear surface portion of the semiconductor wafer can be removed only by etching if the amount of grinding of the rear surface portion is small.

[Modification 4]

The dividing direction of the semiconductor wafer can be set in a direction perpendicular to the rear surface of the wafer or in the same direction as the Si crystallization direction.

[Modification 5]

The damage layers such as the grooves 24-1, 24-2, 24-3, . . . , scratches or distortions 28-1, 28-2, 28-3, . . . , re-crystallization layers 30-1, 30-2, 30-3, . . . , or re-crystallization layers 30A-1, 30A-2, 30A-3, . . . are formed while the dicing tape is kept affixed to the element forming surface side of the semiconductor wafer. However, the damage layers can be formed without using the dicing tape, a protection tape 22 is affixed to the element forming surface 21A before the semiconductor wafer 21 is divided, and then the semiconductor wafer 21 can be divided by breaking and cleaving or by stretching the protection tape 22.

[Modification 6]

A case wherein the protection tape 22 is affixed to the element forming surface 21A side of the semiconductor wafer 21 is explained as an example, but it is possible to affix a protection member other than the tape. For example, adhesive resin is coated on the element forming surface 21A side and a protection plate or holding plate can be affixed to the resin.

[Modification 7]

A case wherein the pickup tape 26 is affixed and used instead of the dicing tape 22, and the discrete semiconductor chips 21-1, 21-2, 21-3, . . . are picked up is explained as an example. However, it is also possible to directly separate the semiconductor chips from the dicing tape 22 and pick up the semiconductor chips.

With the method and the apparatus of the configuration described in the first to seventh modifications, basically the same operation and effect can be attained as those of the first to ninth embodiments.

As described above, according to one aspect of this invention, it is possible to provide a semiconductor device manufacturing method and apparatus with which damages caused by heat or cutting streaks formed on the side surface of the semiconductor chip can be reduced, and a deterioration in the characteristic of the semiconductor chip, occurrence of faults and a lowering in the resistance to bending or breaking can be suppressed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A semiconductor device manufacturing apparatus comprising:
etching equipment which etches a film formed on an element forming surface of a semiconductor wafer, thereby defining a dicing line or a chip-dividing line;
damage forming equipment which forms damage layers used as starting points to divide a semiconductor wafer into discrete semiconductor chips, on a rear surface side of the semiconductor wafer which is opposite to the element forming surface;
dividing equipment which divides the semiconductor wafer into discrete semiconductor chips with the damage layers used as the starting points; and
a removing equipment which removes a rear surface portion of the semiconductor wafer to at least a depth where the damage layers are no more present.

2. The semiconductor device manufacturing apparatus according to claim 1, further comprising an affixing equipment which affixes a protection member to the element forming surface side of the semiconductor wafer.

3. The semiconductor device manufacturing apparatus according to claim 1, wherein the damage forming equipment includes at least one of a diamond blade which forms cut grooves in the rear surface portion of the semiconductor wafer, a scriber which makes scratches or strains in the rear surface portion of the semiconductor wafer and a laser device which applies a laser beam to the rear surface portion of the semiconductor wafer.

4. The semiconductor device manufacturing apparatus according to claim 2, wherein the dividing equipment further includes a stretching equipment which stretches the protection member and divides the semiconductor wafer into the discrete semiconductor chips with the damage layers used as the starting points by stretching the protection member by use of the stretching equipment.

5. The semiconductor device manufacturing apparatus according to claim 1, wherein the etching equipment includes a RIE apparatus.

6. A semiconductor device manufacturing apparatus comprising:
damage forming equipment which forms damage layers used as starting points to divide a semiconductor wafer into discrete semiconductor chips, on a rear surface side of the semiconductor wafer which is opposite to the element forming surface;
hole-making equipment which makes holes in the semiconductor wafer, in dicing lines or chip dividing lines, so that the semiconductor wafer is broken easily along the dicing lines or the chip dividing lines;
dividing equipment which divides the semiconductor wafer into discrete semiconductor chips with the damage layers used as the starting points; and
a removing equipment which removes a rear surface portion of the semiconductor wafer to at least a depth where the damage layers are no more present.

7. The semiconductor device manufacturing apparatus according to claim 6, further comprising an affixing equipment which affixes a protection member to the element forming surface side of the semiconductor wafer.

8. The semiconductor device manufacturing apparatus according to claim 6, wherein the damage forming equipment includes at least one of a diamond blade which forms cut grooves in the rear surface portion of the semiconductor wafer, a scriber which makes scratches or strains in the rear surface portion of the semiconductor wafer and a laser device which applies a laser beam to the rear surface portion of the semiconductor wafer.

9. The semiconductor device manufacturing apparatus according to claim 7, wherein the dividing equipment divides the semiconductor wafer into the discrete semiconductor chips by cleavage with the damage layers used as the starting points.

10. The semiconductor device manufacturing apparatus according to claim 6, wherein the hole-making equipment includes an etching device or a laser device.

11. The semiconductor device manufacturing apparatus according to claim 6, wherein a hole deeper than the damage layers are thick is made in at least one of corners of each semiconductor element.

12. A semiconductor device manufacturing method comprising:
etching a film formed on an element forming surface of a semiconductor wafer, thereby defining a dicing line or a chip-dividing line;
forming damage layers used as starting points to divide a semiconductor wafer into discrete semiconductor chips, on a rear surface side of the semiconductor wafer which is opposite to an element forming surface,
dividing the semiconductor wafer into discrete semiconductor chips with the damage layers used as the starting points, and
removing a rear surface portion of the semiconductor wafer to at least a depth where the damage layers are no more present.

13. The semiconductor device manufacturing method according to claim 12, further comprising affixing a protection member to the element forming surface of the semiconductor wafer before forming the damage layers.

14. The semiconductor device manufacturing method according to claim 12, wherein forming the damage layers is carried out in a direction corresponding to the crystallization direction of the semiconductor wafer.

15. The semiconductor device manufacturing method according to claim 13, wherein dividing the semiconductor wafer into the discrete semiconductor chips is to divide the semiconductor wafer into the discrete semiconductor chips by stretching the protection member.

16. The semiconductor device manufacturing method according to claim 12, wherein the film is etched before the semiconductor wafer is divided into discrete semiconductor chips.

17. A semiconductor device manufacturing method comprising:
forming damage layers used as starting points to divide a semiconductor wafer into discrete semiconductor chips, on a rear surface side of the semiconductor wafer, which is opposite to an element forming surface;
making holes in the semiconductor wafer along a dicing line or a chip-diving line so that the semiconductor wafer may be broken along the dicing line or the chip-dividing line;
dividing the semiconductor wafer into discrete semiconductor chips with the damage layers used as the starting points; and
removing a rear surface portion of the semiconductor wafer to at least a depth where the damage layers are no more present.

18. The semiconductor device manufacturing method according to claim 17, further comprising affixing a protection member to the element forming surface of the semiconductor wafer before forming the damage layers.

19. The semiconductor device manufacturing method according to claim 18, wherein dividing the semiconductor wafer into the discrete semiconductor chips is to divide the semiconductor wafer into the discrete semiconductor chips by stretching the protection member.

20. The semiconductor device manufacturing method according to claim 17, wherein making holes is to perform etching or applying a laser beam.

21. The semiconductor device manufacturing method according to claim 17, wherein making holes is performed before forming the elements, after forming the elements, before the damage layers are formed, or after the damage layers are formed.

22. The semiconductor device manufacturing method according to claim 17, wherein a hole deeper than the damage layers are thick is made in at least one of corners of each semiconductor element.
